(19) United States
(12) Patent Application Publication
(10) Pub. No.: US 2005/0178222 A1
(43) Pub. Date: Aug. 18, 2005

(54) Starter

(75) Inventors: Sadayoshi Kajino, Nagoya (JP); Youichi Hasegawa, Kasugai-shi (JP); Kazuaki Murase, Kounan-shi (JP); Mitsuhiro Murata, Niwa-gun (JP); Tsutomu Shiga, Nukata-gun (JP); Masanori Oomi, Anjo-shi (JP); Tadahiro Kurasawa, Chita-gun (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/036,347

(22) Filed: Jan. 18, 2005

(30) Foreign Application Priority Data
Jan. 16, 2004 (JP) 2004-009702
Feb. 27, 2004 (JP) 2004-054927

(51) Int. Cl. F02N 11/00

(52) U.S. Cl. 74/7 E; 74/7 A

(57) ABSTRACT

A carrier portion includes a side wall portion which restricts shifting of rollers in the axial direction. The side wall portion has a receiving hole formed at a radial central region. A clutch outer, integrally formed with the carrier portion, is rotatably supported via a bearing by a front axial end portion of an armature shaft. The bearing is fixed by press fitting on an inner cylindrical surface of the receiving hole. A tapered portion, provided at an edge of the front axial end portion of the armature shaft, is a guide surface for guiding the armature shaft into the bearing. The length of the front axial end portion is determined in such a manner that the side surface of a sun gear can contact with the side surfaces of the planetary gears in the axial direction after the tapered portion entirely enters inside the bearing.

### CROSS-REFERENCE TO RELATED APPLICATION

This application is based upon and claims the benefit of priority from earlier Japanese Patent Application No. 2004-9702 filed on Jan. 16, 2004 and the Japanese Patent Application No. 2004-54927 filed on Feb. 27, 2004 so that the descriptions of which are incorporated herein by reference.

### BACKGROUND OF THE INVENTION

The present invention relates to a starter including a planetary gear type speed-reduction unit which reduces the rotational speed of a motor. In this speed-reduction unit, the supporting pins of the planetary gears are fixed to an outer plate of a one-way clutch. And, the rotational force is transmitted via this one-way clutch to an output shaft.

This applicant of this invention has already proposed a starter having this kind structure in an earlier patent application (refer to the Japanese Patent Application No. 2003-64791 corresponding to the U.S. patent application Publication No. 2004/0177710 A1).

As shown in FIG. 4, this starter includes a planetary gear type speed-reduction unit 1100 and a one-way clutch 1120. The planetary gear type speed-reduction unit 1100 reduces the rotational speed of a motor. The reduced rotation of the speed-reduction unit 1100 is transmitted via the one-way clutch 1120 to an output shaft 1110. According to this starter, the output shaft 1110 is shifted toward the engine (i.e. in the direction opposed to the motor), so that a pinion gear supported at an end portion of the output shaft 1110 can mesh with a ring gear of the engine. According to this starter, support pins 1140 respectively supporting the planetary gears 1130 are fixed by press fitting to a clutch outer 1150 of the one-way clutch 1120.

In general, the planetary gear type speed-reduction unit 1100 used for a starter has a backlash (i.e. a significant amount of play between teeth meshing with each other) between the planetary gears 1130 and a sun gear 1160 and also has a backlash between the planetary gears 1130 and an internal gear 1170. According to the above-described starter, vibrations caused in the planetary gears 1130 and the support pins 1140 in radial directions are transmitted to the clutch outer 1150 on which the support pins 1140 are fixed. However, when the vibrations of the clutch outer 1150 become larger than a sum of the vibrations of the output shaft 1110 and the vibrations of the clutch inner 1180, the twist movement appears due to the vibrations of the planetary gears 1130 and the support pins 1140. This will produce stresses acting on the support pins 1140 and on the planetary gears 1130, and will cause the wear of the gear bearings 1190 coupling around the support pins 1140 as well as the wear of the tooth faces of the planetary gears 1130. The support pins 1140 may fall off the clutch outer 1150.

Furthermore, the present invention relates to a starter having a cantilever supporting structure, according to which an output shaft is coupled via a helical spline coupling at one end side with an inner cylindrical surface of a tube and is supported at the other end by a bearing fixed to the housing, and further a pinion gear is disposed at an end portion of the output shaft protruding outward from the bearing.

The U.S. patent application Publication No. 2003/0097891 discloses a starter of a so-called cantilever supporting structure which has a pinion gear disposed outside a bearing of an output shaft. The starter disclosed in FIG. 3 of this prior art document includes a drive shaft receiving a driving force of a motor and rotating in response to this driving force and a substantially cylindrical output shaft connected via the helical spline coupling to an outer cylindrical surface of this drive shaft and supported via a bearing by a housing. The pinion gear is provided at an end portion of the output shaft protruding out of the housing from the bearing.

However, according to the above-described conventional starter, the output shaft is supported by only one bearing. When the output shaft protrudes toward the engine relative to the drive shaft, an overhang of the output shaft protruding from the bearing is large. The output shaft will incline easily. As a result, when the pinion gear meshes with the ring gear for cranking the engine, the output shaft rotates in an inclined condition about the bearing. An excessive load acts on the bearing. The lifetime of the bearing will decrease. Furthermore, the output shaft rotating in the inclined condition causes noises.

The applicant of this invention has already proposed a starter including a substantially cylindrical tube and an output shaft. The tube rotates in response to a rotational force transmitted from a motor. The output shaft is connected via a helical spline coupling to an inner cylindrical surface of this tube. A pinion gear is disposed at an end portion of this output shaft. When the pinion gear meshes with a ring gear, a pushing force is given to the output shaft in the axial direction via an engaging member fixed on the output shaft. According to this starter, the tube has a long size in the axial direction. An outer cylindrical surface of this tube is supported at one end side via a first bearing by the center housing. Furthermore, the outer cylindrical surface of this tube is supported at the other end side via a second bearing by the starter housing. A long (i.e. a bearing span) distance is provided between the first and second bearings.

According to this arrangement, when the output shaft protrudes toward the engine to cause the pinion gear to mesh with the ring gear, the bearing span is larger (i.e. longer) than the overhang of the output shaft (i.e. a protruding amount of the output shaft protruding from the second bearing toward the engine). This is effective in suppressing inclination of the output shaft even when the pinion gear meshes with the ring gear for cranking the engine (i.e. when a large load is applied on the output shaft). As a result, the lifetime of the bearing does not decrease. The noise can be eliminated or reduced.

However, according to the prior starter proposed by the applicant of this invention, the tube has a long size in the axial direction. The other end side of the tube is supported via the second bearing by the starter housing. In the inner space of the starter housing, the tube covers the outer side of the output shaft. Accordingly, it is necessary to arrange the engaging member fixed on the output shaft so as to be disposed outside the tube. According to the prior starter proposed by the applicant of this invention, a pin is fixed into a hole opened on the output shaft and a long groove is formed on the tube. The long groove allows the pin to exit out of the tube. The engaging member is fixed to the pin taken out of the tube. The pin is taken out along the long groove.

According to the above-described arrangement, the engaging member must be disposed outside the tube. Thus, the outer diameter of the engaging member becomes large. It is therefore necessary to increase the outer diameter of the starter housing which covers the outer side of the engaging member. This may cause difficulty in installing the starter on the engine. Furthermore, using the long tube or increasing the outer diameter of the engaging member will result in increase of weight.

Furthermore, when the output shaft shifts in axial direction relative to the tube, the long groove formed on the tube shifts while rotating along the torsion angle of the helical spline. The long groove cannot be formed into a simple straight shape along the axial direction. It is necessary to form the inclined long groove substantially corresponding to the torsion angle of the helical spline. The processing or machining required for the long groove is complicated.

Furthermore, the output shaft cannot be directly fixed to the engaging member. An appropriate pin for connecting the output shaft and the engaging member is required. The process of fixing this pin to the output shaft (i.e. a process of opening a hole on the output shaft into which the pin is inserted) is necessary. Furthermore, it is necessary to fix the engaging member to the pin. In this manner, the structure of the starter is complicated and the manufacturing processes for realizing this structure are also complicated. This will increase the manufacturing costs.

### SUMMARY OF THE INVENTION

In view of above-described problems, the present invention has an object to provide a starter which is capable of suppressing vibrations occurring in the clutch outer and also capable of suppressing the twist movement occurring due to vibrations of the planetary gears and the support pins.

To accomplish the above and other related objects, the present invention provides a first starter including a motor, a planetary gear type speed-reduction unit, a tube, a one-way clutch, an output shaft, a pinion gear, a side wall portion, and support pins. According to the first starter of this invention, the motor has an armature for generating a rotational force. The planetary gear type speed-reduction unit, including a sun gear provided on an armature shaft (i.e. rotary shaft) of the armature and planetary gears meshing with the sun gear and with an internal gear, reduces a rotational speed of the armature based on an orbital motion of the planetary gears. The tube, having a substantially cylindrical body, is rotatably supported at one axial end side by a bearing. The other axial end side of this tube is a free end. The one-way clutch, using the tube as a clutch inner and including a clutch outer serving as a driving side rotary member, transmits a torque from the clutch outer to the clutch inner via rollers. An output shaft is disposed coaxially with the armature shaft, with one axial end side being rotatably and slidably supported by a bearing and the other axial end side being connected via a spline coupling to an inner cylindrical surface of the tube. The pinion gear, supported on the output shaft, shifts integrally with the output shaft toward a ring gear of an engine, and the pinion gear can mesh with the ring gear. The side wall portion, integrally formed with the clutch outer, restricts shifting of the rollers in the axial direction. The support pins, fixed on the side wall portion, rotatably support the planetary gears via gear bearings.

Furthermore, according to the first starter of the present invention, a front axial end portion is provided on the armature shaft. The front axial end portion protrudes forward than the sun gear. The side wall portion has a receiving hole formed at a radial central region thereof for rotatably supporting the front axial end portion of the armature shaft via a bearing disposed in the receiving hole.

According to the above-described arrangement, the side wall portion is integrally formed with the clutch outer and is rotatably supported via the bearing by the front axial end portion of the armature shaft. This arrangement makes it possible to adequately suppress the vibration width of the clutch outer relative to the armature shaft. This arrangement suppresses the twist movement occurring due to vibrations of the planetary gears and the support pins. This arrangement prevents the support pins from falling off the side wall portion. Furthermore, it becomes possible to suppress the wear of the gear bearings coupling around the support pins as well as the wear of the tooth faces of the planetary gears. As a result, the torque transmission loss can be reduced. Smooth rotation is realized. Furthermore, gear noise (i.e. the noise generating when the gears mesh with each other) of the speed-reduction unit can be reduced.

According to the first starter of the present invention, it is preferable that the relationship A<B is satisfied when ‘A’ represents a vibration width of the clutch outer displaceable in a radial direction relative to the armature shaft, and ‘B’ represents a vibration width of the planetary gears displaceable in the radial direction relative to the armature shaft.

According to the above-described arrangement, the radial vibration width B of the planetary gears is larger than the radial vibration width A of the clutch outer. When the clutch outer causes vibrations in the radial direction relative to the armature shaft, the stress acting on the planetary gears and the support pins can be reduced without causing the interference between the planetary gears and the sun gear as well as the interference between the planetary gears and the internal gear. Furthermore, this arrangement suppresses the twist movement occurring due to vibrations of the clutch outer and the planetary gears. The torque transmission loss can be reduced. Smooth rotation is realized. Furthermore, the gear noise of the speed-reduction unit can be reduced.

According to the first starter of the present invention, it is preferable that the relationship D>A+C is satisfied when ‘A’ represents a vibration width of the clutch outer displaceable in a radial direction relative to the armature shaft, ‘C’ represents a vibration width of the output shaft displaceable in the radial direction, and ‘D’ represents a vibration width of the clutch inner displaceable in the radial direction.

According to the above-described arrangement, the vibration width D of the clutch inner is set to be larger than the sum of the vibration width A of the clutch outer and the vibration width C of the output shaft. The vibrations of the clutch outer can be absorbed by the vibrations of the clutch inner. As a result, this arrangement can suppress the twist movement occurring due to vibrations of the clutch outer and the output shaft. Smooth torque transmission is realized.

According to the first starter of the present invention, it is preferable that the front axial end portion of the armature shaft is inserted in the bearing in a condition that the bearing is fixed by press fitting to an inner cylindrical surface of the receiving hole formed on the side wall portion. A tapered portion is provided at an edge of the front axial end portion so as to surround entirely in a circumferential direction. The tapered portion guides the front axial end portion in a process of inserting the front axial end portion into the bearing. And, the sun gear contacts with the planetary gears in the axial direction, after the tapered portion is placed in the bearing.

According to the above-described arrangement, the tapered portion is provided on the front axial end portion of the armature shaft. The tapered portion can smoothly guide the front axial end portion in the process of inserting the front axial end portion into the bearing. Furthermore, according to this arrangement, the sun gear can contact with the planetary gears in the axial direction after the tapered portion of the front axial end portion entirely enters inside the bearing. In other words, the tapered portion of the front axial end portion is already positioned inside the bearing at the moment the sun gear is brought into contact with the planetary gears in the axial direction. The rotation center of the sun gear automatically agrees with the orbital center of the planetary gears. As a result, the sun gear can smoothly mesh with the planetary gears. The assembling work of the armature is easy.

Furthermore, in view of the above-described problems, the present invention provides a novel starter having a so-called cantilever supporting structure, according to which a pinion gear is disposed outside a bearing of an output shaft (i.e. disposed at an end portion of the output shaft protruding from the bearing). More specifically, the present invention has an object to provide a starter capable of downsizing the housing in radial size so that the degree of freedom in assembling the starter to the engine can be improved and simplifying the structure to reduce the total number of constituent parts and also reduce the weight.

In order to accomplish the above and other related objects, the present invention provides a second starter including a motor, a tube, an output shaft, and a pinion gear, which is a starter having a so-called cantilever supporting structure. According to the second starter of this invention, the motor generates a rotational force. The tube, having a substantially cylindrical body, rotates in response to the rotational force transmitted from the motor. The output shaft is coupled via a helical spline coupling at one axial end side with an inner cylindrical surface of the tube. The output shaft protrudes out of the tube at the other axial end side and is rotatably and slidably supported by a first bearing fixed to the housing. The pinion gear, integrally or separately disposed on an end portion of the output shaft protruding outward (toward the engine) from the first bearing, transmits the rotational force transmitted from the tube via the output shaft to a ring gear of an engine. An inner cylindrical surface of the tube is rotatably supported at one end side via a second bearing by a bearing portion provided on a rotary shaft of the motor. An outer cylindrical surface of the tube is rotatably supported at the other end side via a third bearing by the housing or by a structural member supported by the housing.

According to the above-described arrangement, both axial ends of the tube can be stably supported via the second and third bearings by the housing. Furthermore, the output shaft is coupled at one end side with the inner cylindrical surface of the tube via the helical spline coupling. The output shaft is supported at the other end side via the first bearing by the housing. Therefore, both end sides of the output shaft can be stably supported. As a result, it becomes possible to prevent the output shaft from being inclined even when the pinion gear meshes with the ring gear for cranking the engine. The load acting on the bearing (especially, on the first bearing) can be reduced. This is effective in preventing the bearing from being worn out. A long lifetime of the bearing is assured.

The second starter of this invention further includes the output shaft shifting means for shifting the output shaft toward the engine so that the pinion gear can mesh with the ring gear of the engine. The output shaft shifting means includes an engaging member and actuating means. The engaging member is fixed to the output shaft protruding from the tube toward the ring gear. The actuating means gives the pushing force acting in the axial direction to the output shaft via the engaging member. According to this arrangement, the engaging member is not disposed outside the tube. Furthermore, the engaging member can be directly fixed to the output shaft. Thus, the engaging member can be downsized in radial size. Furthermore, the housing accommodating this engaging member therein can be downsized in radial size.

Furthermore, the axial length of the tube can be shortened. The outer diameter of the engaging member can be reduced. The weight of the starter can be reduced. Furthermore, directly fixing the engaging member to the output shaft makes it possible to omit the process of forming a long groove (i.e. a long groove extending along the torsion angle of the helical spline) on the tube. Furthermore, it is unnecessary to connect the output shaft and the engaging member by means of a pin or the like. This is effective in reducing the total number of required constituent parts. The structure of the starter can be simplified. The assembling of the constituent parts becomes easy. Reduction in costs is realized.

According to the second starter of this invention, it is preferable that the second bearing is fixed to the inner cylindrical surface of the tube by press fitting. According to this arrangement, in the process of assembling the constituent parts of the starter, the output shaft is inserted along the inner cylindrical surface of the tube. Then, the second bearing is assembled to the inner cylindrical surface of the tube at one end side. The second bearing can serve as a stopper of the output shaft. Thus, assembling work of the starter is easy. The second bearing of the second starter can be selected from the group consisting of a ball bearing, a roller bearing, other type of rolling members, a plane bearing, and other type of slide bearings.

It is preferable that the second starter of this invention further includes a clutch for allowing or prohibiting power transmission between the motor and the tube. The clutch includes a clutch outer and a clutch inner rotatably coupled with each other. The clutch outer is directly or indirectly driven by the motor. The clutch inner receives the power of the motor transmitted from the clutch outer, and the clutch inner is formed as part of the tube.

According to this arrangement, the axial length of the tube includes the length of the clutch inner. This is advantageous in providing a long span (i.e. a long axial support span) ranging from one end side to the other end side of the output shaft. The one end side of the output shaft is supported via the helical spline coupling by the tube. The other end side of the output shaft is supported via the first bearing by the housing. Thus, a relatively long axial support span is provided compared with an overhang of the output shaft which protrudes toward the engine to cause the pinion gear to mesh with the ring gear. As a result, during the cranking operation of the engine, the stress acting on the output shaft can be reduced. Accordingly, the starter of this arrangement has a stable cantilever supporting structure. Furthermore, due to reduction of the stress acting on the output shaft, the output shaft can be downsized in radial size as well as in weight.

It is further preferable that the second starter of this invention includes a planetary gear type speed-reduction unit having planetary gears causing an orbital motion for reducing the rotation of the motor. The clutch outer is provided with a carrier portion to which gear shafts are integrally or separately fixed for rotatably supporting the planetary gears. And, the carrier portion has a coupling hole rotatably coupling around the outer cylindrical surface of the tube at one end. According to this arrangement, the clutch outer can be centered via the planetary gear type speed-reduction unit relative to the rotary shaft of the motor. Furthermore, the clutch inner (i.e. the tube) can be centered via the second bearing relative to the rotary shaft of the motor. Thus, this arrangement prevents the clutch from being decentered, and accordingly assures stable clutch performance.

Furthermore, according to the second starter of this invention, it is preferable that the clutch has an outer plate provided integrally with the clutch outer. The outer plate has a bore opened at a radial central region. A driven gear or a direct spline is formed on an inner side of the bore. And, the driven gear or the direct spline meshes with a drive gear or a direct spline formed on the rotary shaft of the motor, so that the clutch outer is directly driven by the motor. According to the above-described arrangement, the clutch outer can be directly centered relative to the rotary shaft of the motor. Furthermore, the clutch inner (i.e. the tube) can be centered via the second bearing relative to the rotary shaft of the motor. Thus, this arrangement prevents the clutch from being decentered, and accordingly assures stable clutch performance.

Furthermore, according to the second starter of this invention, it is preferable that the actuating means includes an electromagnetic switch and a rotation restricting member. The electromagnetic switch generates an electromagnetic force. The rotation restricting member is driven by the electromagnetic force generated from the electromagnetic switch and engages with the engaging member to restrict rotation of the output shaft before the output shaft starts rotating. The output shaft shifts toward the engine under a condition that rotation of the output shaft is restricted by the rotation restricting member, by using the rotational force of the motor and a function of the helical spline. According to the above-described arrangement, when the electromagnetic switch restricts the rotation of the output shaft, the electromagnetic switch activates the rotation restricting member so that the rotation restricting member can engage with the engaging member. The electromagnetic switch is thus required to generate an electromagnetic force only required for activating the rotation restricting member. The electromagnetic switch can be downsized.

Furthermore, according to the second starter of this invention, it is preferable that the actuating means includes an electromagnetic switch generating an electromagnetic force and a shift lever driven by the electromagnetic switch. The output shaft shifts toward the engine in response to a pushing force given via the shift lever to the engaging member in the axial direction. According to this arrangement, the shift lever is actuated by the electromagnetic force generated by the electromagnetic switch. The shift lever transmits the pushing force acting in the axial direction to the engaging member. Thus, the output shaft can be surely shifted toward the engine. It becomes possible to provide a reliable starter.

Moreover, in order to accomplish the above and other related objects, the present invention provides a third starter including a motor, a tube, an output shaft, and a pinion gear, which is a starter having a so-called cantilever supporting structure. The motor generates a rotational force. The tube, having a substantially cylindrical body, rotates in response to the rotational force transmitted from the motor. The output shaft is coupled at one axial end side with an inner cylindrical surface of the tube via a helical spline coupling. The output shaft protrudes out of the tube at the other axial end side and is rotatably and slidably supported by a bearing fixed to the housing. The pinion gear, integrally or separately disposed on an end portion of the output shaft protruding outward (toward the engine) from the bearing, transmits the rotational force transmitted from the tube via the output shaft to a ring gear of an engine. The third starter of this invention further includes output shaft shifting means for shifting the output shaft toward the engine so that the pinion gear can mesh with the ring gear.

The output shaft shifting means of the third starter includes an engaging member, a rotation restricting member, an electromagnetic switch, and the output shaft. The engaging member is fixed to the output shaft protruding from the tube toward the ring gear. The rotation restricting member is engageable with the engaging member before the output shaft starts rotating so as to restrict rotation of the output shaft. The electromagnetic switch generates an electromagnetic force to drive the rotation restricting member. And, the output shaft shifts toward the engine under a condition that rotation of the -output shaft is restricted by the rotation restricting member, by using the rotational force of the motor and a function of the helical spline.

According to the above-described arrangement, the engaging member is not disposed outside the tube. Furthermore, directly fixing the engaging member to the output shaft is effective in reducing the outer diameter of the engaging member. Furthermore, the housing surrounding the engaging member can be downsized in radial size. Furthermore, the axial length of the tube can be shortened. The outer diameter of the engaging member can be reduced. The weight of the starter can be reduced.

Furthermore, directly fixing the engaging member to the output shaft makes it possible to omit the process of forming a long groove (i.e. a long groove extending along the torsion angle of the helical spline) on the tube. Furthermore, it is unnecessary to connect the output shaft and the engaging member by means of a pin or the like. This is effective in reducing the total number of required constituent parts. The structure of the starter can be simplified. The assembling of the constituent parts becomes easy. Reduction in costs is realized.

According to the second or third starter of this invention, it is preferable that the electromagnetic switch performs an open and close control of a contact means for selectively supplying electric power to the motor. In this case, it is possible to use a common electromagnetic switch for performing the open and close control of the contact means and for controlling the actuating means.

According to the second or third starter of this invention, it is preferable that the engaging member fixed to the output shaft collides with an end surface of the tube during a shifting movement of the output shaft returning from the vicinity of the ring gear of the engine, so that the tube acts as a stopper for receiving a rearward shifting force of the output shaft and stopping the output shaft. According to this arrangement, it is unnecessary to prepare a special part or component for stopping the rear shifting movement of the output shaft. Thus, it becomes possible to provide a simple stopper arrangement without increasing the total number of constituent parts.

Furthermore, it is preferable that the second or third starter of this invention further including a return spring generating an elastic force for pushing the output shaft back against a shifting movement of the output shaft toward the engine. The return spring is disposed between an outer cylindrical surface of the output shaft being inserted into an inner space of the tube and an inner cylindrical surface of the tube. The return spring has one end supported by a spring receiving portion provided on the outer cylindrical surface of the output shaft. And, the return spring has the other end supported by a spring receiving portion provided on the inner cylindrical surface of the tube.

According to this arrangement, the relative rotation between the output shaft and the tube is very small (because rotations of the output shaft and the tube are substantially identical) even when the pinion gear is driven by the ring gear after the engine is ignited and the output shaft is in an overrunning condition. Therefore, no washer or comparable rotation absorbing member is necessary for the return spring. As a result, the simple arrangement is realized without increasing the total number of constituent parts. Reduction in costs is realized.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a cross-sectional view partly showing a starter in accordance with a first embodiment of the present invention;

FIG. 2 is an enlarged cross-sectional view showing a clutch and its peripheral arrangement in accordance with the first embodiment of the present invention;

FIG. 3 is a view explaining vibrations occurring in respective portions of the starter in accordance with the first embodiment of the present invention;

FIG. 4 is a cross-sectional view showing a conventional clutch and its peripheral arrangement;

FIG. 5 is a cross-sectional view showing a starter in accordance with a second embodiment of the present invention;

FIG. 6 is an enlarged cross-sectional view showing a tube and its peripheral arrangement in accordance with the second embodiment of the present invention;

FIG. 7 is a cross-sectional view showing a bearing supporting an inner cylindrical surface of the tube in accordance with the second embodiment of the present invention;

FIG. 8 is an electric circuit diagram for the starter in accordance with the second embodiment of the present invention; and

FIG. 9 is a cross-sectional view showing a starter in accordance with a third embodiment of the present invention.

### DESCRIPTION OF THE PREFERRED EMBODIMENTS

Preferred embodiments of the present invention will be explained hereinafter with reference to attached drawings.

### First Embodiment

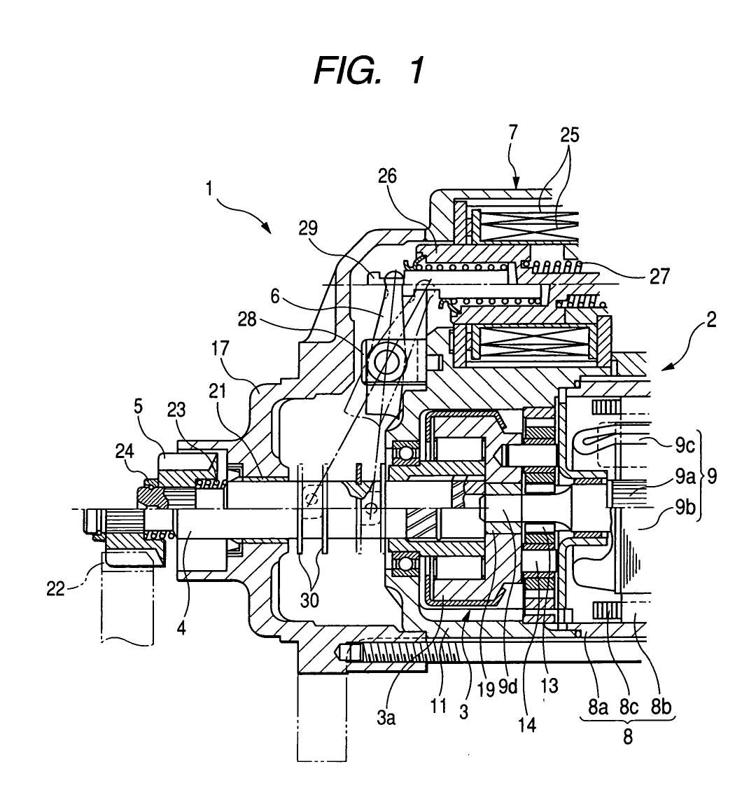

FIG. 1 is a cross-sectional view partly showing a starter in accordance with a first embodiment of the present invention. The starter 1 of this embodiment includes a motor 2, a speed-reduction unit (which is later described), a one-way clutch 3, an output shaft 4, a pinion gear 5, a shift lever 6, and an electromagnetic switch 7. The motor 2 generates a rotational force. The speed-reduction unit reduces the rotational speed of the motor 2. The rotation reduced by the speed-reduction unit is transmitted via the one-way clutch 3 to the output shaft 4. The pinion gear 5 is disposed on the output shaft 4. The electromagnetic switch 7 opens and closes a main contact (not shown) provided in a power supply circuit of the motor 2. 5Furthermore, the electromagnetic switch 7 generates a force which is transmitted via the shift lever 6 to the output shaft 4 to shift the output shaft 4 in the axial direction.

The motor 2 is a direct-current motor including a field 8, an armature 9, and the brush (not shown) etc. The field 8 generates a magnetic flux. The armature 9 has a commutator (not shown). The brush is disposed on this commutator. When electromagnetic switch 7 closes the main contact, the motor 2 receives starting current from a vehicle battery (not shown) and the armature 9 generates a rotational force. The field 8 includes field poles 8b fixed on an inner cylindrical surface of a yoke 8a forming a part of the magnetic circuit. A field coil 8c is wounded around the field poles 8b. The field 8 is not limited to a coil type field and accordingly can be arranged by a magnet type field.

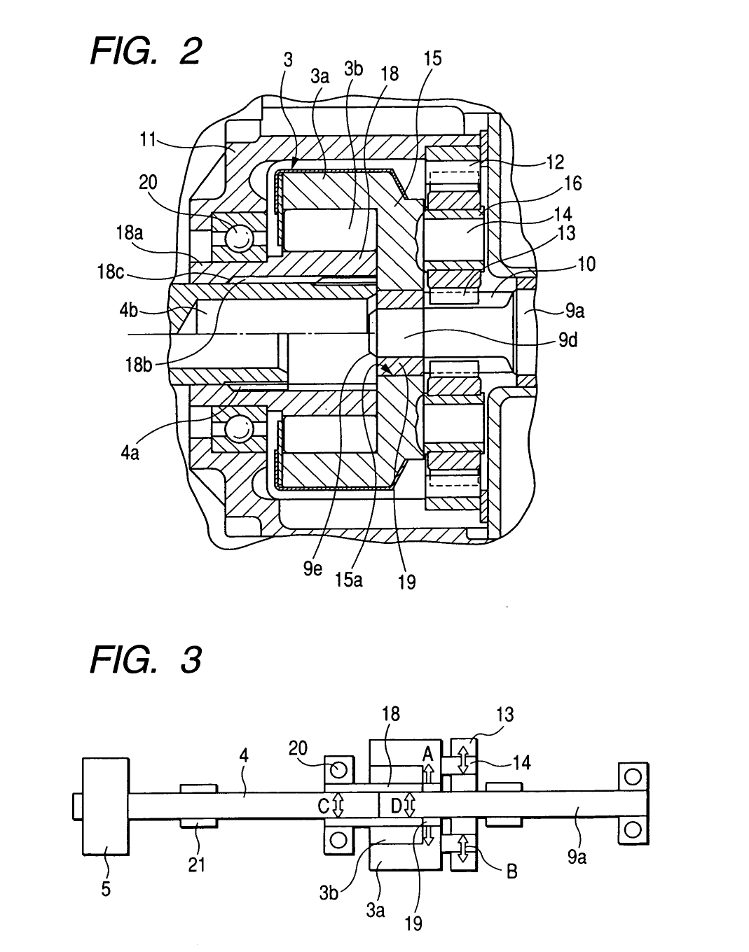

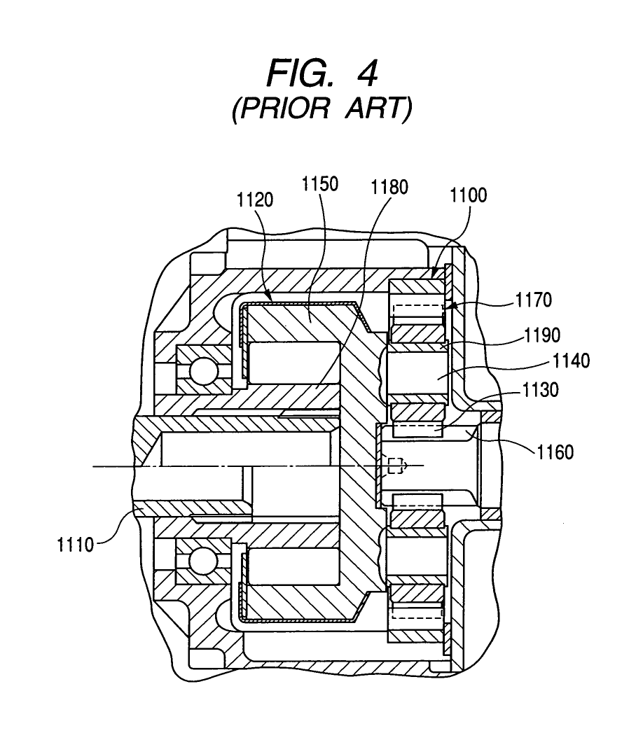

The armature 9 includes an armature shaft 9a, an armature core 9b, and an armature coil 9c. The armature shaft 9a is rotatably supported. The armature core 9b is fixed to the armature shaft 9a. The armature coil 9c is wounded around the armature core 9b. As shown in FIG. 2, a sun gear 10 and a front axial end portion 9d are provided at one end side (i.e. left side in the drawing) of the armature shaft 9a. The sun gear 10 is a constituent component of the speed-reduction unit. The front axial end portion 9d protrudes forward than the sun gear 10. The front axial end portion 9d has an outer diameter smaller than a bottom diameter of the sun gear 10. A tapered portion 9e is provided on the edge of the front axial end portion 9d so as to surround entirely in the circumferential direction.

The speed-reduction unit is a well known planetary gear type speed-reduction unit consisting of the above-described sun gear 10, an internal gear 12, a plurality of planetary gears 13 meshing with both of the gear 10 and the internal gear 12. The internal gear 12 is stationarily fixed to a center casing 11. The planetary gears 13 are supported via support pins 14 by a carrier portion 15. The speed-reduction unit reduces the rotational speed of the armature 9 to an orbital speed of the planetary gears 13. Each planetary gear 13 is rotatably supported via a gear bearing 16 by the corresponding support pin 14. Each support pin 14 is fixed by press fitting to the carrier portion 15.

The center casing 11 is disposed between the yoke 8a of the motor 2 and a front housing 17. The center casing 11 covers the outside of the speed-reduction unit and the one-way clutch 3. The one-way clutch 3 includes a clutch outer 3a, a tube 18, and rollers 3b. The clutch outer 3a is integrally formed with the carrier portion 15. The tube 18, having a substantially cylindrical body, forms a clutch inner positioned at a radial inner side of the clutch outer 3a. Respective rollers 3b are disposed in a cam box (not shown) formed inside the clutch outer 3a. The torque is transmitted from the clutch outer 3a via the roller 3b to the tube 18 (i.e. clutch inner). Namely, the clutch outer 3a is a driving side rotary member, while the tube 18 is a driven side rotary member.

The carrier portion 15 is a side wall portion of this invention which restricts shifting of rollers 3b in the axial direction toward the motor (i.e. rightward in FIG. 1). The carrier portion 15 (i.e. side wall portion) has a receiving hole 15a formed at a radial central region thereof. The clutch outer 3a, integrally formed with the carrier portion 15 (i.e. side wall portion), is rotatably supported by the front axial end portion 9d of the armature shaft 9a via a bearing 19 (e.g. a needle bearing) disposed on an inner cylindrical surface of the receiving hole 15a, as shown in FIG. 2. The bearing 19 is fixed by press fitting on the inner cylindrical surface of the receiving hole 15a. The front axial end portion 9d of the armature shaft 9a is inserted into the bearing 19.

The armature shaft 9a is provided with the tapered portion 9e (refer to FIG. 2) at the edge of the front axial end portion 9d so as to surround entirely in the circumferential direction. The tapered portion 9e is a guide surface for guiding the armature shaft 9a in the process of inserting the armature shaft 9a into the bearing 19. Furthermore, the length of the front axial end portion 9d is determined in such a manner that the side surface of the sun gear 10 can contact with the side surfaces of the planetary gears 13 in the axial direction after the tapered portion 9e entirely enters inside the bearing 19. As shown in FIG. 2, the tapered portion 9e protrudes toward the clutch (i.e. the left side of FIG. 2) than the bearing 19 in a condition that the front axial end portion 9d is inserted in the bearing 19.

The tube 18 has bearing portion 18a provided at one axial end side (left side in the drawing) as shown in FIG. 2. The ball bearing 20 is disposed on an outer cylindrical surface of the bearing portion 18a. In other words, the tube 18 is rotatably supported via the ball bearing 20 by the center casing 11. The other axial end side of the tube 18 is a free end. The tube 18 has a female helical spline 18b formed on an inner cylindrical surface thereof. The female helical spline 18b extends from the other end of the tube 18 to a portion located at a radial inner side of the bearing portion 18a. The terminal end (i.e. end portion) of the female helical spline 18b is a stopper 18c which stops the axial shifting movement of the output shaft 4 relative to the tube 18.

The output shaft 4 is disposed coaxially with the armature shaft 9a of the motor 2, although the speed-reduction unit and the one-way clutch 3 are disposed between them. The output shaft 4 has one end side supported via a bearing 21 by the front housing 17 and the other end side inserted into an inner cylindrical space of the tube 18. The output shaft 4 has a male helical spline 4a (refer to FIG. 2) formed on an outer cylindrical surface thereof. The male helical spline 4a engages with the female helical spline 18b. With this arrangement, the output shaft 4 can rotate integrally with the tube 18, while the output shaft 4 is shifable in the axial direction relative to the tube 18.

Furthermore, the output shaft 4 has an inner bore 4b (refer to FIG. 2) extending in the axial direction at a rear end portion thereof. The bore 4b stores the lubricating oil. FIG. 1 illustrates the output shaft 4 separately about its center line. The upper half of the output shaft 4 shows a stationary condition of the starter 1, while the lower half of the output shaft 4 shows an operating condition of the starter 1. In the operating condition of the starter 1, the output shaft 4 advances forward to cause the pinion gear 5 to mesh with a ring gear 22 of the engine.

The pinion gear 5 is, for example, fixed via a spline coupling to the front end portion of the output shaft 4 protruding forward than the bearing 21. The pinion gear 5 rotates integrally with the output shaft 4. The pinion gear 5 receives a reaction force acting from a pinion spring 23. The pinion spring 23 is disposed between the pinion gear 5 and the output shaft 4. The pinion spring 23 resiliently pushes the pinion gear 5 toward the engine (i.e. to the left in FIG. 1). The pinion gear 5 can shift along the output shaft 4. A collar 24 attached at the front end portion of the output shaft 4 firmly holds the pinion gear 5. A retracted position of the pinion gear S relative to the output shaft 4 should be restricted by an overall compression amount of the pinion spring 23.

The electromagnetic switch 7 includes an exciting coil 25, a plunger 26, and a return spring 27. The exciting coil 25 receives electric power from a battery when the starter switch (not shown) is closed. The plunger 26 is magnetically drawn by a magnetic force generated by the exciting coil 25. The return spring 27 gives a resilient force to the plunger 26 so that the plunger 26 can return to its home position when the exciting coil 25 is deactivated (i.e. when the magnetic force disappears). The main contact is opened and closed in accordance with the shifting movement of the plunger 26. On the other hand, the electromagnetic switch 7 cooperates with the shift lever 6 to shift the output shaft 4 in the axial direction via.

The shift lever 6 is swingably supported by a lever holder 28. The lever holder 28 is fixed to the center casing 11. The upper end of the shift lever 6 is connected to a hook 29. The hook 29 is held by the plunger 26. The lower end of the shift lever 6 is sandwiched between a pair of parallel washers 30 provided on the output shaft 4. With this arrangement, the shift lever 6 transmits the movement of the plunger 26 to the output shaft 4. FIG. 1 illustrates the plunger 26 separately about its center line. The upper half of the plunger 26 shows a stationary condition of the electromagnetic switch 7, while the lower half of the plunger 26 shows an operating condition of the electromagnetic switch 7. In the operating condition of the electromagnetic switch 7, electric power is supplied to the exciting coil 25.

The starter 1 in accordance with this embodiment satisfies the following relationships:
A<B (1)
D>A+C (2)
where ‘A’ represents a vibration width of the clutch outer 3a displaceable in the radial direction relative to the armature shaft 9a, ‘B’ represents a vibration width of the planetary gears 13 displaceable in the radial direction relative to the armature shaft 9a, ‘C’ represents a vibration width of the output shaft 4 displaceable in the radial direction, and ‘D’ represents a vibration width of the clutch inner (i.e. tube 18) displaceable in the radial direction, as shown in FIG. 3.

Next, the operation of the starter 1 will be explained.

When the starter switch is closed, electric power is supplied to the exciting coil 25 of the electromagnetic switch 7. The plunger 26 is magnetically drawn. The movement of the plunger 26 is transmitted via the shift lever 6 to the output shaft 4. The output shaft 4 moves toward the engine (i.e. in the direction opposed to the motor). When the pinion gear 5 provided on the output shaft 4 can smoothly mesh with the ring gear 22 of the engine, the main contact is closed and the armature 9 generates a rotational force.

On the other hand, in a case the pinion gear 5 cannot smoothly mesh with the ring gear 22, the pinion gear 5 will collide with the ring gear 22. In this case, the output shaft 4 can continuously advance against the resilient force of the pinion spring 23. The pinion gear 5 slides on the output shaft 4 so as to move rearward relative to the output shaft 4. Then, in accordance with the shifting movement of the output shaft 4, the pinion gear 5 may rotate to an angular position where the pinion gear 5 can mesh with the ring gear 22. At this moment, the pinion gear 5 is pushed forward by the reaction force of the pinion spring 23. The pinion gear 5 meshes with the ring gear 22. Then, the main contact is closed and the armature 9 generates a rotational force.

When the engagement of the pinion gear 5 and the ring gear 22 is completed, the rotational force is transmitted from the pinion gear 5 to the ring gear 22 for cranking the engine. When the starter switch is opened after the engine starts its operation, no electric power is supplied to the exciting coil 25 and accordingly the magnetic force disappears. The plunger 26 is pushed back to the home position by the reaction force of the return spring 27. In accordance with the shifting motion of the plunger 26, the main contact is opened and no electric power is supplied to the armature 9. Furthermore, in accordance with the returning movement of the plunger 26 being pushed back, the shift lever 6 causes the output shaft 4 to return to the home position. The rear end surface (i.e. the end surface closer to the motor) of the output shaft 4 is stopped by the carrier portion 15.

According to this embodiment, the front axial end portion 9d is provided on the front end portion (i.e. the end portion closer to the pinion) of the armature shaft 9a. The armature shaft 9a supports the sun gear 10 at an axial position far from the pinion gear than the front axial end portion 9d. Accordingly, the front axial end portion 9d protrudes forward (i.e. toward the pinion gear) than the sun gear 10. The front axial end portion 9d is smaller in outer diameter than the sun gear 10. The planetary gear type speed-reduction unit is disposed at the radial outer side of the sun gear 10. The one-way clutch 3 is disposed at the pinion gear side of this planetary gear type speed-reduction unit. The one-way clutch 3 is rotatably supported. The one-way clutch 3 has the clutch inner (i.e. tube 18) which is rotatably supported via the ball bearing 20 by the center casing 11.

The center casing 11 has an annular wall surface protruding perpendicularly and in the radial inward direction from its cylindrical outer wall portion at a front side of (i.e. a position closer to the pinion gear) of the one-way clutch 3. The ball bearing 20 is held by the annular wall surface of the center casing 11. Accordingly, the center casing 11 has a substantially cylindrical body with the annular wall surface constituting its bottom. An opened top of the center casing 11 faces the motor. The cylindrical outer wall portion of the center casing 11 defines a chamber in which both the planetary gear type speed-reduction unit and the one-way clutch 3 are accommodated. A groove extending in the axial direction is formed at the lowermost side of the inner wall surface defining this accommodation chamber. The one-way clutch 3 has the side wall portion 15 (i.e. carrier portion) facing to the planetary gear type speed-reduction unit. The side wall portion 15 has the receiving hole (a through-hole or a bore with a bottom) 15a which receives the front axial end portion 9d. The bearing 19, disposed in the hole 15a, supports the front axial end portion 9d.

The one-way clutch 3 has the side wall portion 15 as part of its clutch outer 3a. The side wall portion 15 is positioned next to the planetary gear type speed-reduction unit. The bearing 19, disposed on the side wall portion 15, supports the front axial end portion 9d. The diameter of the hole 15a provided on the side wall portion 15 is slightly larger than or substantially equal to the outer diameter of the sun gear 10 at one side closer to the planetary gear type speed-reduction unit. The diameter of the hole 15a provided on the side wall portion 15 is smaller than the inner diameter of the tube 18 constituting the clutch inner, at the other side closer to the one-way clutch 3. Furthermore, in comparison with the output shaft 4 disposed inside the tube 18, the diameter of the hole 15a provided on the side wall portion 15 is smaller than the outer diameter of the output shaft 4 and is larger than the inner diameter of the bore 4b formed in the output shaft 4, at the side closer to the one-way clutch 3.

### Effect of the First Embodiment

The starter 1 in accordance with the first embodiment has the clutch outer 3a integrally formed with the carrier portion 15. The clutch outer 3a is rotatably supported via the bearing 19 by the front axial end portion 9d of the armature shaft 9a. This arrangement makes it possible to adequately suppress vibrations of the clutch outer 3a occurring in the radial direction relative to the armature shaft 9a. The above-described relationship (1) can be satisfied. This embodiment suppresses the twist movement occurring due to vibrations of the planetary gears 13 and the support pins 14. This embodiment prevents the support pins 14 from falling off the carrier portion 15. Furthermore, it becomes possible to suppress the wear of the gear bearings 16 coupling around the support pins 14 as well as the wear of the tooth faces of the planetary gears 13. As a result, the transmission loss of the motor torque transmitted via the speed-reduction unit and the one-way clutch 3 to output shaft 4 can be reduced. Smooth rotation is realized. Furthermore, gear noise (i.e. the noise generating when the gears mesh with each other) of the speed-reduction unit can be reduced. Thus, the starter 1 of this embodiment is silent.

Furthermore, the starter 1 in accordance with the first embodiment satisfies the above-described relationship (2). Namely, the vibration width D of the clutch inner (i.e. tube 18) is set to be larger than the sum of the vibration width A of the clutch outer 3a and the vibration width C of the output shaft 4 The vibrations of the clutch outer 3a can be absorbed by the vibrations of the clutch inner (i.e. tube 18). As a result, this embodiment can suppress the twist movement occurring due to vibrations of the clutch outer 3a and the output shaft 4. Smooth torque transmission is realized.

Furthermore, the tapered portion 9e is provided on the front axial end portion 9d of the armature shaft 9a. The tapered portion 9e can guide the front axial end portion 9d in the process of inserting the front axial end portion 9d into the bearing 19. Furthermore, the length of the front axial end portion 9d is determined in such a manner that the sun gear 10 can contact with the planetary gears 13 in the axial direction after the tapered portion 9e entirely enters inside the bearing 19. In other words, the tapered portion 9e of the front axial end portion 9d is already positioned inside the bearing 19 at the moment the side surface of the sun gear 10 is brought into contact with the side surfaces of the planetary gears 13 in the axial direction. The rotation center of the sun gear 10 automatically agrees with the orbital center of the planetary gears 13. As a result, the sun gear 10 can smoothly mesh with the planetary gears 13. The assembling work of the armature 9 is easy.

### Second Embodiment

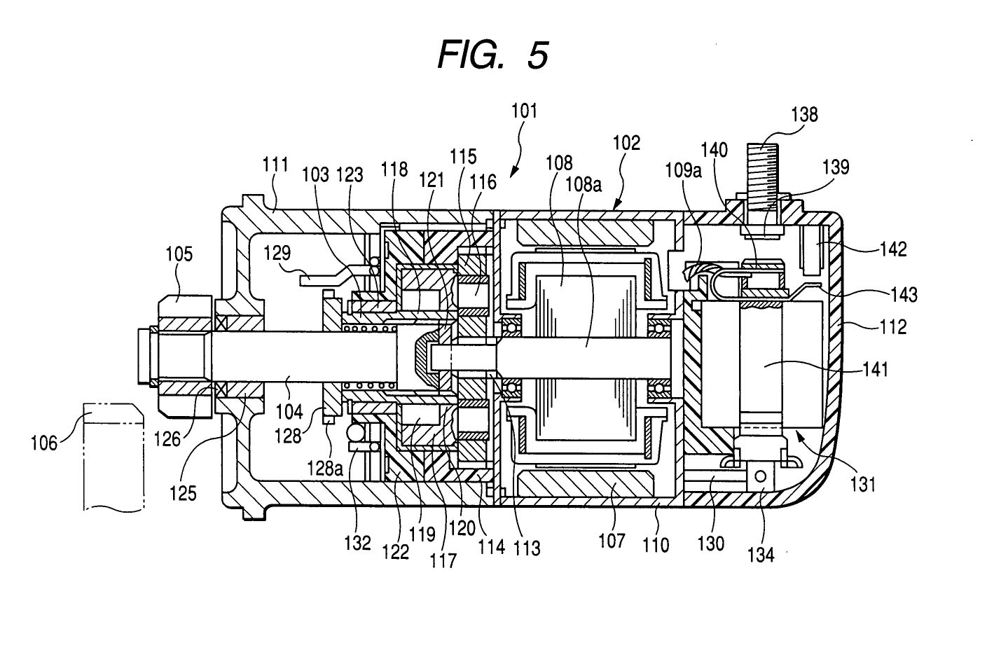

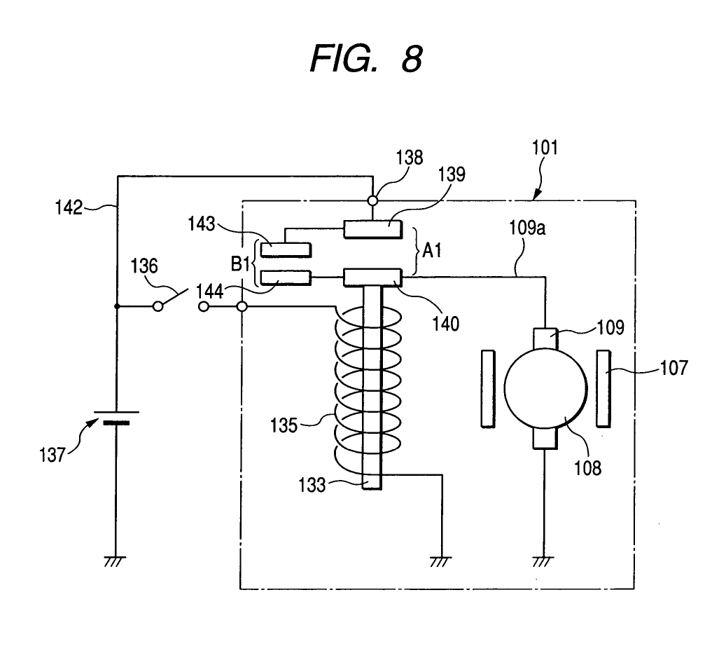

FIG. 5 is a cross-sectional view a starter 101 in accordance with a second embodiment of the present invention. FIG. 8 is an electric circuit diagram for the starter 101 in accordance with the second embodiment of the present invention.

The starter 101 of this embodiment includes a motor 102, a tube 103, an output shaft 104, a pinion gear 105, and an output shaft shifting device (later described). The motor 102 generates a rotational force. The tube 103, having a substantially cylindrical body, receives the rotational force of the motor 102 transmitted via a speed-reduction unit and a clutch (both being later-described). The output shaft 104 is provided so as to be shiftable in the axial direction along an inner cylindrical surface of the tube 103. The pinion gear 105 is attached to an end portion of the output shaft 104. The output shaft shifting device shifts the output shaft 104 toward the engine (i.e. toward the side in FIG. 5) so that the pinion gear 105 can mesh with a ring gear 106 of the engine.

The motor 102 is a well known direct-current motor including a field 107 (e.g. a magnet type filed according to the example shown in FIG. 5 or a coil type field) generating a magnetic flux, an armature 108 having a commutator, and brushes 109 slidably contacting with the commutator (refer to FIG. 8). The motor 102 interposes between a front housing 111 and an end frame 112. A yoke 110, forming the magnetic circuit of the field 107, serves as a frame body of the motor 102. These members are fastened together by means of through bolts (not shown).

The speed-reduction unit has a well known planetary gear mechanism including a sun gear 113 formed on the rotary shaft of the motor 102 (hereinafter, referred to as armature shaft 108a) and a plurality of planetary gears 115 each meshing with the sun gear 113 at a radial inner side and with an internal gear 114 at a radial outer side. The speed-reduction unit reduces the rotational speed of the armature 108 to the orbital speed of the planetary gears 115.

The clutch consists of a clutch outer 117, a clutch inner 118, and clutch rollers 119. The orbital motion of the planetary gears 115 (i.e. the reduced motor rotation) is transmitted to the clutch outer 117 via gear shafts 116 which rotatably support the planetary gears 115. The clutch inner 118 forms a part of the tube 103. The clutch rollers 119 are disposed between the clutch outer 117 and the clutch inner 118. This clutch is the one-way clutch which only permits the torque transmission from the clutch outer 117 to the clutch inner 118 (i.e. to the tube 103) via the clutch rollers 119. In other words, this clutch prohibits the torque transmission from the clutch inner 118 to the clutch outer 117.

A carrier portion 120, integrally formed with the clutch outer 117, support the gear shafts 116 of the planetary gears 115. A circular coupling hole, opened at a radial central region of the carrier portion 120, couples around the outer cylindrical surface of the tube 103. The gear shafts 116 are integrally formed with the carrier portion 120. Alternatively, it is possible to separately form the gear shafts 116 and later fix these gear shafts 116 to the carrier portion 120. For example, the press fitting will be preferably used to fix respective gear shafts 116 into engaging holes opened on the carrier portion 120.

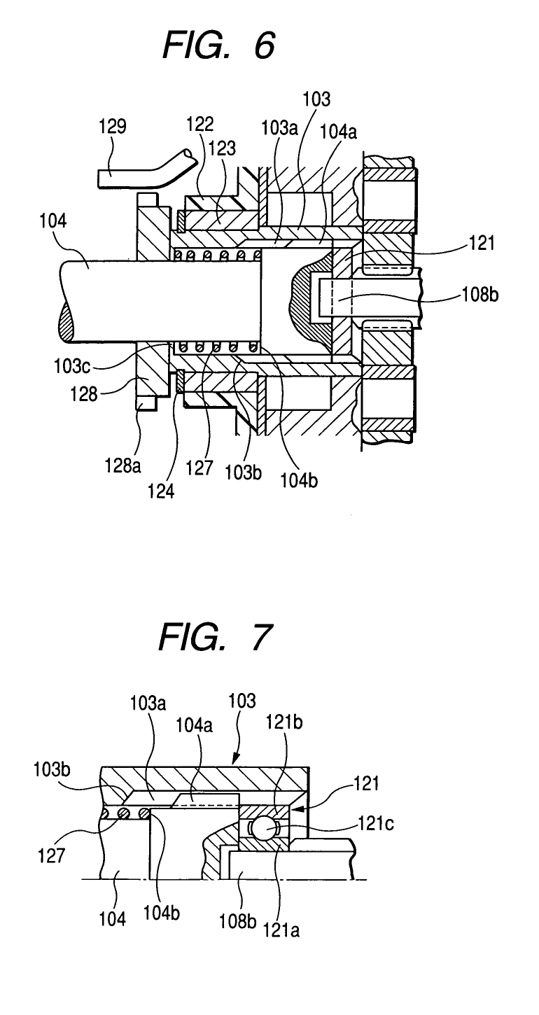

The tube 103, as shown in FIG. 6, has a female helical spline 103a form on a substantially cylindrical inner cylindrical surface thereof. The inner cylindrical surface of the tube 103 (i.e. inner cylindrical surface of the female helical spline 103a), at one axial end side (i.e. the right side of FIG. 6) where the female helical spline 103a is formed, is supported by a bearing portion 108b provided on the armature shaft 108a of the motor 102 via a bearing 121 (serving as the second bearing of the present invention), so as to be rotatable relative to the bearing portion 108b. An outer cylindrical surface of the tube 103 is rotatably supported, at the other axial end side, via a bearing 123 by a center casing 122 (serving as a structural member of the present invention) which is fixed to the front housing 111.

According to the tube 103 of this embodiment, the outer diameter of one outer cylindrical surface contacting with the bearing 123 is slightly smaller than the outer diameter of the other outer cylindrical surface serving as the clutch inner 118. A step is provided between these two outer cylindrical surfaces. The bearing 123 is sandwiched between this step and a fixing member 124 provided at the other end side (far from the end surface of the clutch). The fixing member 124, such as a washer or a stopper ring, is 20 fixed on the outer cylindrical surface of the tube 103. Thus, the step and the fixing member 124 cooperatively restrict the shift movement of the bearing 123 in the axial direction. Furthermore, the female helical spline 103a form on the inner cylindrical surface of the tube 103 extends from one axial end of the tube 103 to an intermediate portion near than the other axial end side. The intermediate portion where the female helical spline 103a terminates is configured into a stopper 103b which stops the output shaft 104 shifting toward the engine.

The bearing 121 supporting the inner cylindrical surface of the tube 103 is, as shown in FIG. 7, a ball bearing consisting of an inner race 121a, an 30 outer race 121b, and balls 121c (rolling members). The balls 121c, intervening between the inner race 121a and the outer race 121b, allow relative rotations of the inner race 121a and the outer race 121b. The inner race 121a is coupled by loose fitting around an outer cylindrical surface of the bearing portion 108b provided on the armature shaft 108a. The outer race 121b is fixed by press fitting on the inner cylindrical surface of the tube 103 (i.e. the inner cylindrical surface of the female helical spline 103a). In stead of using the ball bearings, it is possible to use other rolling members such as roller bearings.

The output shaft 104 has a larger-diameter portion at one axial end side as shown in FIG. 6. The larger-diameter portion is slightly larger in outer diameter than the remaining portion. The larger-diameter portion has a male helical spline 104a formed on its outer cylindrical surface. The male helical spline 104a meshes with the female helical spline 103a formed on the inner cylindrical surface of the tube 103. As shown in FIG. 5, the other end side of the output shaft 104 is a smaller-diameter portion which is smaller in outer diameter than the larger-diameter portion. The smaller-diameter portion protrudes out of the end surface of the tube 103 and extends toward the engine (i.e. to the left in FIG. 5). The front end of the output shaft 104 is rotatably and slidably supported by a bearing 125 fixed to the end portion of the front housing 111. The outer side of the bearing 125 (i.e. the left side in FIG. 5) is provided with a seal member 126 which prevents the foreign substances from entering through the clearance between the bearing 125 and the output shaft 104.

When the output shaft 104 causes a shift movement relative to the tube 103 toward the engine, an end portion of the male helical spline 104a collides with the terminal end (i.e. stopper 103b) of the female helical spline 103a and the shift movement of the output shaft 104 is stopped. The tube 103 surrounds the output shaft 104 (smaller-diameter portion). A return spring 127 (refer to FIG. 6), disposed between the outer cylindrical surface of the output shaft 104 (smaller-diameter portion) and the inner cylindrical surface of the tube 103, gives an elastic force for pushing the output shaft 104 back toward the motor. The return spring 127 has one end supported by the step 104b (serving as a spring receiving portion of the present invention) provided on the outer cylindrical surface of the output shaft 104 between the larger-diameter portion and the smaller-diameter portion. The return spring 127 has the other end supported by a spring receiving portion 103c provided at an inner side of the other end portion of the tube 103.

The pinion gear 105 is connected via a spline coupling to the end portion of the output shaft 104 protruding outward (toward the engine) from the bearing 125. The pinion gear 105 is integrally rotatably with the output shaft 104. The output shaft shifting device includes an engaging member 128, a rotation restricting rod 129, and an electromagnetic switch 131. The engaging member 128, having a ring shape, is fixed to the output shaft 104. The rotation restricting rod 129 extends perpendicularly to a rotational direction of the engaging member 128 (i.e. the rotational direction of the output shaft 104) and is engageable with the engaging member 128. The electromagnetic switch 131 actuates the rotation restricting rod 129 via a connecting bar 130.

The engaging member 128 is fixed by press fitting on outer cylindrical surface of the output shaft 104 (smaller-diameter portion) protruding from the end surface of the tube 103 toward the ring gear 106 of the engine. The engaging member 128 is rigidly fixed to the output shaft 104 in both the axial and circumferential directions. Furthermore, the engaging member 128 has a convexo-concave portion 128a continuously provided on its outer cylindrical surface. The convexo-concave portion 128a extends in the circumferential direction and is engageable with the rotation restricting rod 129. The method for fixing the engaging member 128 to the output shaft 104 is not limited to the press fitting coupling. Accordingly, any other method (e.g. knurl coupling) can be used to rigidly fix the engaging member 128 to the output shaft 104 in both the axial and circumferential directions.

It is needless to say that the fixing position of the engaging member 128 relative to the output shaft 104 is an inner side in the axial direction (i.e. an axial position closer to the motor) than the bearing 125 supporting the output shaft 104. Furthermore, the fixing position of the engaging member 128 corresponds to a position where the engaging member 128 is brought into contact with the front end surface of the tube 103 in a stationary condition of the starter 101 (i.e. the condition shown in FIG. 5). The engaging member 128 has a function of a stopper which stops the output shaft 104 at the stationary position. More specifically, the output shaft 104 returns to the stationary position of FIG. 5 when it is urged by the reaction force of return spring 127 after the output shaft 104 once shifts toward the ring gear 106 of the engine. The engaging member 128 collides with the front end surface of the tube 103.

The rotation restricting rod 129 is integrally formed via the connecting bar 130 with an arm portion 132 (refer to FIG. 5) for receiving an electromagnetic force of the electromagnetic switch 131. As a practical example, a rodlike spring material is formed into a ring shape. Both end portions of the ring shaped spring material are bent perpendicularly to the same direction at the positions substantially opposed in the radial direction. One end is configured into the rotation restricting rod 129 and the other end portion is configured into the arm portion 132.

The rotation restricting rod 129 is disposed at an outer side of the engaging member 128 in the radial direction with a slight clearance, as shown in FIG. 5. The arm portion 132 is pushed downward in the drawing when the electromagnetic force of the electromagnetic switch 131 acts on the arm portion 132. The rotation restricting rod 129 is pushed downward together with the arm portion 132 in this case. The rotation restricting rod 129 engages with the convexo-concave portion 128a of the engaging member 128 to restrict the rotation of the engaging member 128. On the other hand, as soon as the electromagnetic force of the electromagnetic switch 131 disappears, the rotation restricting rod 129 disengages from the convexo-concave portion 128a of the engaging member 128 by a reaction force of a spring (not shown). The rotation restricting rod 129 and the arm portion 132 return together to the positions shown in FIG. 5.

The connecting bar 130 transmits the electromagnetic force of the electromagnetic switch 131 to the arm portion 132. For example, the connecting bar 130 has a crank shape formed by bending a rodlike metallic member by predetermined angles at both end sides. One end side of the connecting bar 130 is connected via a hook 134 (refer to FIG. 5) to a plunger 133 (refer to FIG. 8) of the electromagnetic switch 131. The other end side of the connecting bar 130 is directly engaged with the arm portion 132. The electromagnetic switch 131, when used as the above-described output shaft shifting device, performs open and close operations for the contact means (i.e. a main contact A1 and a sub contact B1) provided in the power supply circuit of the motor 102 shown in FIG. 8. The electromagnetic switch 131 consists of an exciting coil 135 (refer to FIG. 8), the above-described plunger 133, and a return spring (not shown). As shown in FIG. 5, the electromagnetic switch 131 is disposed at the rear end of the starter 101 (i.e. at the behind side of the motor 102 far from the engine). The end frame 112 covers the outer side of the electromagnetic switch 131.

The exciting coil 135 receives electric power from a battery 137 via a starter switch 136 (i.e. ignition switch) as shown in FIG. 8. The exciting coil 135 generates a magnetic force in response to supplied electric power. The plunger 133, inserted in the inner space of the exciting coil 135, is magnetically drawn toward a magnetized stationary core (not shown) when the exciting coil 135 generates the magnetic force. The plunger 133 shifts upward in FIG. 5 to close both the sub contact B1 and the main contact A1. The return spring pushes the plunger 133 back to the home position when the exciting coil 135 is deactivated (i.e. when the magnetic force disappears), so as to open both the main contact A1 and the sub contact B1.

The main contact A1 consists of a first stationary contact 139 and a first movable contact 140. The first stationary contact 139 is connected via a terminal bolt 138 to the plus (+) electrode of the battery 137. The first movable contact 140 is connected via a brush lead line 109a to a brush 109 having a positive polarity (refer to FIG. 8). The first movable contact 140 is held by a contact holder 141. The contact holder 141 is insulated from the first movable contact 140 and is connected to the plunger 133. The first movable contact 140 is opposed to the first stationary contact 139 and is integrally movable together with the plunger 133. The terminal bolt 138 extends from the inside to the outside of the end frame 112 as shown in FIG. 5. The first stationary contact 139 is integrally provided on the terminal bolt 138 at the inner side of the end frame 112. A battery cable 142 (refer to FIG. 8) is connected to a male screw portion of the terminal bolt 138 at the outer side of the end frame 112.

The sub contact B1 consists of a second stationary contact 143 and a second movable contact 144. The second stationary contact 143 is electrically connected to the first stationary contact 139. The second movable contact 144 is integrally formed with the first movable contact 140. The second movable contact 144 is opposed to the second stationary contact 143 and causes a shift motion relative to the second stationary contact 143. The second stationary contact 143 is made of a carbon material or a comparable material having an electric resistance larger than that of the first stationary contact 139. For example, the second stationary contact 143 is fixed to the terminal bolt 138 via a metallic plate (not shown). The second movable contact 144 is, for example, a metallic plate which is bent into a U-shaped configuration so as to have an appropriate elastic force.

The main contact Al and the sub contact B1 are arranged in such a manner that the sub contact B1 closes earlier than the main contact A1 to suppress the rotational speed of the armature 108 in a startup period of the motor 102 (i.e. during a short period of time before the pinion gear 105 meshes with the ring gear 106). More specifically, as shown in FIG. 8, a gap between the second stationary contact 143 and the second movable contact 144 cooperatively forming the sub contact B1 is shorter than a gap between the first stationary contact 139 and the first movable contact 140 cooperatively forming the main contact A1.

The operation of the starter 101 will be explained hereinafter.

When the starter switch 136 is closed, the exciting coil 135 of the electromagnetic switch 131 is activated and generates a magnetic force. The plunger 133 is magnetically drawn by the generated magnetic force and shifts upward in FIG. 5. The shifting motion of the plunger 133 is transmitted via the connecting bar 130 to the arm portion 132. Both of the arm portion 132 and the rotation restricting rod 129 shift downward in FIG. 5. The rotation restricting rod 129 engages with the convexo-concave portion 128a of the engaging member 128, thereby restricting the rotation of the output shaft 104.

Furthermore, in the shifting process of the plunger 133, the sub contact B1 closes earlier than the main contact A1. As the second stationary contact 143 has a larger electric resistance, a smaller starting current flows from the battery 137 to the armature 108. The armature 108 rotates at lower speeds. The rotation of the armature 108 is further reduced by the speed-reduction unit and is transmitted via the clutch to the tube 103. Thus, the tube 103 rotates at lower speeds. In this case, the rotation of the output shaft 104 is restricted. Thus, the rotational force of the tube 103 is converted into a thrust force (i.e. an advance force) due to the function of the helical spline. The converted thrust force (i.e. advance force) acts on the output shaft 104. As a result, the output shaft 104 shifts forward (i.e. toward the engine).

According to the shifting movement of the output shaft 104, the pinion gear 105 disposed on the output shaft 104 can smoothly engage with the ring gear 106 of the engine. Thereafter, the rotation restricting rod 129 disengages from the convexo-concave portion 128a of the engaging member 128. The rotation restricting rod 129 moves into the rear side of the engaging member 128 (i.e. the side closer to the tube 103), thereby releasing the rotation restrict of the output shaft 104. Furthermore, the front edge of the rotation restricting rod 129 supports the rear end surface of the engaging member 128, thereby restricting the rearward movement of the output shaft 104. It is preferable to attach a thrust bearing (not shown) on the rear side of the engaging member 128, so that the front end of the rotation restricting rod 129 is brought into contact with this thrust bearing. In this case, the thrust bearing can absorb the rotation of the engaging member 128 and accordingly can suppress the deformation of the rotation restricting rod 129.

On the other hand, when the side surfaces of the pinion gear 105 and the ring gear 106 collide with each other, the pinion gear 105 and the ring gear 106 cannot smoothly engage with each other. At this moment, the shifting motion of the output shaft 104 is stopped. The rotational force of the tube 103 is not yet converted into the thrust force. The rotational force of the tube 103 is used to rotate the output shaft 104. At this moment, the rotation of the output shaft 104 is restricted by the rotation restricting rod 129. As the spring material forming the rotation restricting rod 129 has elasticity, the rotation restricting rod 129 allows a slight rotation (for example, a rotation corresponding to a single tooth of the pinion gear 105) of the output shaft 104 under the condition that the rotation restricting rod 129 is engaged with the convexo-concave portion 128a of the engaging member 128. As a result of this slight rotation, the output shaft 104 can reach an angular position where the pinion gear 105 can mesh with the ring gear 106. Then, the output shaft 104 receives the thrust force and advances forward. The pinion gear 105 can mesh with the ring gear 106.

Thereafter, at the moment the main contact A1 is closed, a large current flows into the motor 102 via the main contact A1 which has an electric resistance smaller than that of the sub contact B1. Thus, the armature 108 rotates at higher speeds. The high-speed rotation of the armature 108 is reduced by the speed-reduction unit. The reduced rotation is then transmitted via the clutch to the tube 103. The output shaft 104 and the tube 103 integrally rotate at higher speeds. The rotational force is transmitted to the engine via the pinion gear 105 and the ring gear 106, thereby cranking the engine.

When the starter switch 136 is opened after the engine starts its operation, no electric power is supplied to the exciting coil 135 and accordingly the magnetic force disappears. The plunger 133 is pushed back to the home position by a reaction force of the return spring. In accordance with the shifting motion of the plunger 133, the arm portion 132 is released from the force applied via the connecting bar 130. The rotation restricting rod 129 is thus released from the pushing force acting downward in FIG. 5. The rotation restricting rod 129 and the arm portion 132 return together to the upper positions by a reaction force of the spring. As a result, the rotation restricting rod 129 is pulled out from the rear side of the engaging member 128. The rear shifting movement of the output shaft 104 is no longer restricted. The output shaft 104 is pushed back toward the motor 102 by a reaction force of the return spring 127. The engaging member 128 collides with the end surface of the tube 103 and stops at the stationary position.

### Effect of the Second Embodiment

According to the above-described starter 101, the inner cylindrical surface of the tube 103 (i.e. the inner cylindrical surface of the female helical spline 103a) is rotatably supported at one axial end side via the bearing 121 by the bearing portion 108b provided on the armature shaft 108a of the motor 102. The outer cylindrical surface of the tube 103 is rotatably supported at the other axial end side via the bearing 123 by the center casing 122. The output shaft 104 is coupled at one end side with the inner cylindrical surface of the tube 103 via the helical spline coupling. The output shaft 104 is supported at the other end side via the bearing 125 by the end portion of the front housing 111. Therefore, both end sides of the output shaft 104 can be stably supported. As a result, it becomes possible to prevent the output shaft 104 from being inclined even when the pinion gear 105 meshes with the ring gear 106 for cranking the engine. The load acting on the bearing (especially, on the bearing 125) can be reduced. This is effective in preventing the bearing 125 from being worn out. A long lifetime of the bearing 125 is assured.

Furthermore, the clutch inner 118 is formed as part of the tube 103. Namely, the axial length of the tube 103 includes the length of the clutch inner 118. This is advantageous in providing a long axial support span ranging from one end side to the other end side of the output shaft 104. The one end side of the output shaft 104 is supported via the helical spline coupling by the tube 103. The other end side of the output shaft 104 is supported via the bearing 125 by the end portion of the front housing 111. Thus, a relatively long axial support span is provided compared with an overhang of the output shaft 104 which protrudes toward the engine to cause the pinion gear 105 to mesh with the ring gear 106. As a result, during the cranking operation of the engine, the stress acting on the output shaft 104 can be reduced. Accordingly, the starter 101 of this embodiment has a stable cantilever supporting structure. Furthermore, due to reduction of the stress acting on the output shaft 104, the output shaft 104 can be downsized in radial size as well as in weight.

The starter 101 disclosed in the second embodiment has the ring-shaped engaging member 128 which is directly fixed on the outer cylindrical surface of the output shaft 104 (i.e. the smaller-diameter portion) protruding from the end surface of the tube 103. In this case, the engaging member 128 can be downsized in radial size compared with the above-described conventional starter. The front housing 111 having an inner space for accommodating the engaging member 128 can be also downsized in outer diameter. The installability of the starter 101 to the engine is good.

The degree of freedom in assembling the starter 101 to the engine can be improved.

Furthermore, directly fixing the engaging member 128 to the output shaft 104 makes it possible to omit the process of forming a long groove (i.e. a long groove extending along the torsion angle of the helical spline) on the tube 103. Furthermore, it is unnecessary to connect the output shaft 104 and the engaging member 128 by means of a pin or the like. This is effective in reducing the total number of required constituent parts. The structure of the starter 101 can be simplified. The assembling of the constituent parts becomes easy. Furthermore, it is unnecessary to extend the other end side of the tube 103 to the end portion of the front housing 111. The overall length of the tube 103 can be shortened. Furthermore, due to downsizing of the engaging member 128 as well as the above-described downsizing of the output shaft 104, the weight of the starter 101 can be reduced.

Furthermore, during the shifting movement of the output shaft 104 returning from the engine side to the motor side, the engaging member 128 fixed to the output shaft 104 collides with the end surface of the tube 103. The tube 103 acts as a stopper for receiving a rearward shifting force of the output shaft 104 and stopping the output shaft 104. Therefore, this embodiment requires no special part or component for receiving the rearward shifting force of the output shaft 104 and stopping the output shaft 104. Thus, this embodiment provides a stopper arrangement without increasing the cost.

Furthermore, the return spring 127 is disposed between the inner cylindrical surface of the tube 103 and the outer cylindrical surface of the output shaft 104. The return spring 127 is used to push the output shaft 104 back to the home position. The return spring 127 is sandwiched between the step 104b (i.e. spring receiving portion) provided on the output shaft 104 and the spring receiving portion 103c of the tube 103. According to this arrangement, the relative rotation between the output shaft 104 and the tube 103 is very small (because rotations of the output shaft 104 and the tube 103 are substantially identical) even when the pinion gear 105 is driven by the ring gear 106 after the engine is ignited and the output shaft 104 is in an overrunning condition. Therefore, no washer or comparable rotation absorbing member is necessary for the return spring 127.

According to the starter 101 disclosed in the second embodiment, the bearing 121 supporting the inner cylindrical surface of the tube 103 at one end side is for example a ball bearing. The bearing 121 is supported by the bearing portion 108b provided on the armature shaft 108a. The outer race 121b of this ball bearing is fixed by press fitting on the inner cylindrical surface of the tube 103. The inner race 121a is coupled by loose fitting around the outer cylindrical surface of the bearing portion 108b. According to this arrangement, the ball bearing is capable of preventing the output shaft 104 from falling off in the assembling processes of respective constituent parts of the starter 101. Namely, the output shaft 104 is pushed by the reaction force of the return spring 127. The ball bearing (i.e. the bearing 121) prevents the output shaft 104 from falling off the tube 103. The assembling of other parts can be facilitated.

Furthermore, the starter 101 disclosed in the second embodiment includes the planetary gear type speed-reduction unit for reducing the rotational speed of the motor 102. The gear shafts 116 respectively supporting the planetary gears 115 are integrally or separately fixed on the carrier portion 120 of the clutch outer 117. Furthermore, the carrier portion 120 has a circular coupling hole formed at the radial central region. The outer cylindrical surface of the tube 103 is rotatably coupled at one end side into the carrier portion 120. According to this arrangement, the clutch outer 117 can be centered via the planetary gear type speed-reduction unit relative to the armature shaft 108a. Furthermore, the clutch inner 118 (i.e. the tube 103) can be centered via the bearing 121 relative to the armature shaft 108a. Thus, this embodiment prevents the clutch from being decentered and accordingly assures stable clutch performance.

### Third Embodiment

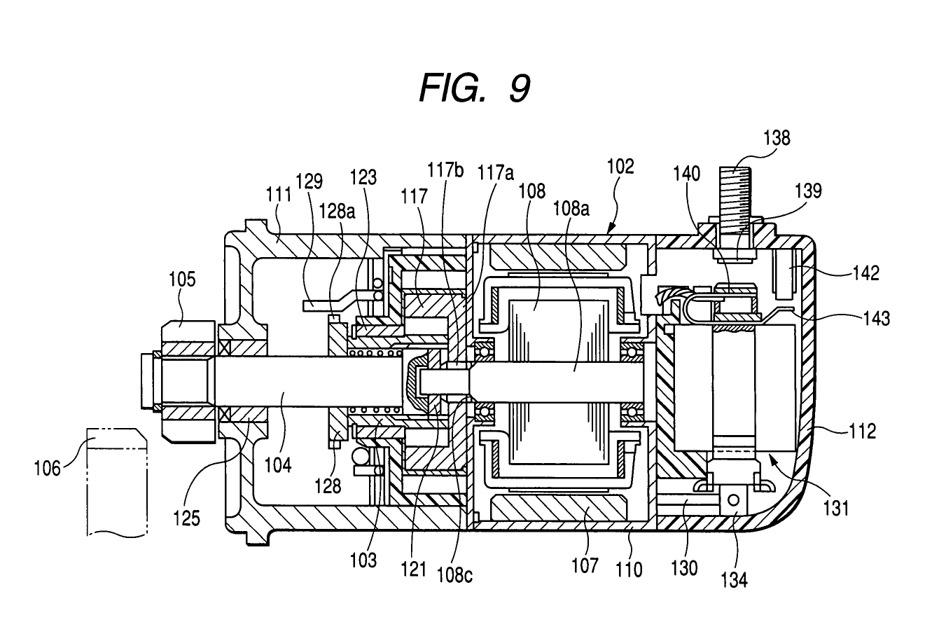

FIG. 9 is a cross-sectional view showing a starter 101 in accordance with a third embodiment of the present invention. The starter 101 according to the third embodiment is a type according to which the rotational speed of the armature 108 is not reduced and is transmitted via the clutch to the tube 103. The starter 101 according to the third embodiment differs from the starter 101 according to the second embodiment in that the speed-reduction unit is not provided between the motor 102 and the clutch. The rest of the arrangement of the starter 101 according to the third embodiment is fundamentally identical with those of the starter 101 disclosed in the second embodiment. The connecting structure of the motor 102 and the clutch according to the third embodiment will be explained hereinafter.

The clutch includes an outer plate 117a provided integrally with the clutch outer 117. The outer plate 117a has a bore opened at a radial central region. A driven gear 117b (or a direct spline) is formed on the inner side of this bore. The driven gear 117b (or the direct spline) meshes with a drive gear 108c (or direct spline) formed on the armature shaft 108a. Thus, the clutch outer 117 is directly driven by the motor 102.

According to the above-described arrangement, the output shaft 104 is stably supported. Thus, the third embodiment provides the starter 101 having a stable cantilever supporting structure, like the starter 101 shown in the second embodiment. Furthermore, the clutch outer 117 can be directly centered relative to the armature shaft 108a. Furthermore, the clutch inner 118 (i.e. tube 103) can be also centered via the bearing 121 (i.e. ball bearing) relative to the armature shaft 108a. Thus, this embodiment is capable of preventing the clutch from being decentered. Stable clutch performance can be assured.

### Modified Example

According to the above-described second and third embodiments, the means for shifting the output shaft 104 toward the engine includes the engaging member 128 fixed on the output shaft 104 and the rotation restricting rod 129 engaging with the engaging member 128. According to this arrangement, the output shaft 104 can shift toward the engine under a condition that rotation of the output shaft 104 is restricted by the rotation restricting member, by using the rotational force of the motor 102 and a function of the helical spline. It is however possible to employ a mechanism using a shift lever for pushing the output shaft 104. In this case the shift lever is driven by the electromagnetic force of the electromagnetic switch 131. The output shaft 104 shifts toward the engine in response to a pushing force given in the axial direction via the shift lever to the engaging member 128 fixed on the output shaft 104.

Furthermore, the starter 101 disclosed in the above-described second or third embodiment includes two bearings 121 and 123 to support the tube 103. It is however possible to use only one bearing (for example, only the bearing 123) to support the tube 103. In this case, compared with the starter 101 disclosed in the second or third embodiment, the supporting stability for the output shaft 104 may slightly deteriorate. However, downsizing the engaging member 128 in radial size is feasible by directly fixing (for example, by press fitting) the engaging member 128 to the output shaft 104 at a portion protruding from the end surface of the tube 103. At the same time, the outer diameter of the front housing 111 can be reduced.

Although the second and third embodiments disclose the ball bearing as one example of the bearing 121, it will be possible to use other type of rolling members, such as the roller bearing and the plane bearing, for the bearing 121.

1. A starter comprising:
a motor having an armature for generating a rotational force;
a planetary gear type speed-reduction unit including a sun gear provided on an armature shaft of said armature and planetary gears meshing with said sun gear and with an internal gear, for reducing a rotational speed of said armature based on an orbital motion of said planetary gears;
a tube having a substantially cylindrical body and rotatably supported at one axial end side by a bearing, with the other axial end side being a free end;
a one-way clutch using said tube as a clutch inner and including a clutch outer serving as a driving side rotary member, for transmitting a torque from said clutch outer to said clutch inner via rollers;
an output shaft disposed coaxially with said armature shaft, with one axial end side being rotatably and slidably supported by a bearing and the other axial end side being connected via a spline coupling to an inner cylindrical surface of said tube;
a pinion gear supported on said output shaft and shifting integrally with said output shaft toward a ring gear of an engine so that said pinion gear can mesh with said ring gear; and
a front axial end portion provided on said armature shaft and protruding forward than said sun gear, said front axial end portion being supported via a bearing by said tube or said clutch outer.

2. A starter comprising:
a motor having an armature for generating a rotational force;
a planetary gear type speed-reduction unit including a sun gear provided on an armature shaft of said armature and planetary gears meshing with said sun gear and with an internal gear, for reducing a rotational speed of said armature based on an orbital motion of said planetary gears;
a tube having a substantially cylindrical body and rotatably supported at one axial end side by a bearing, with the other axial end side being a free end;
a one-way clutch using said tube as a clutch inner and including a clutch outer serving as a driving side rotary member, for transmitting a torque from said clutch outer to said clutch inner via rollers;
an output shaft disposed coaxially with said armature shaft, with one axial end side being rotatably and slidably supported by a bearing and the other axial end side being connected via a spline coupling to an inner cylindrical surface of said tube;
a pinion gear supported on said output shaft and shifting integrally with said output shaft toward a ring gear of an engine so that said pinion gear can mesh with said ring gear;
a side wall portion integrally formed with said clutch outer for restricting shifting of said rollers in the axial direction; and
support pins fixed on said side wall portion for rotatably supporting said planetary gears via gear bearings, wherein
a front axial end portion is provided on said armature shaft and protrudes forward than said sun gear, and
said side wall portion has a receiving hole formed at a radial central region thereof for rotatably supporting said front axial end portion of said armature shaft via a bearing disposed in said receiving hole.

3. The starter in accordance with claim 2, wherein the relationship A<B is satisfied when ‘A’ represents a vibration width of said clutch outer displaceable in a radial direction relative to said armature shaft, and ‘B’ represents a vibration width of said planetary gears displaceable in the radial direction relative to said armature shaft.

4. The starter in accordance with any claim 2, wherein the relationship D>A+C is satisfied when ‘A’ represents a vibration width of said clutch outer displaceable in a radial direction relative to said armature shaft, ‘C’ represents a vibration width of the output shaft displaceable in the radial direction, and ‘D’ represents a vibration width of the clutch inner displaceable in the radial direction.

5. The starter in accordance with any one of claim 2, wherein said front axial end portion of said armature shaft is inserted in said bearing in a condition that said bearing is fixed by press fitting to an inner cylindrical surface of said receiving hole formed on said side wall portion,
a tapered portion is provided at an edge of said front axial end portion so as to surround entirely in a circumferential direction for guiding said front axial end portion in a process of inserting said front axial end portion into said bearing, and
said sun gear contacts with said planetary gears in the axial direction after said tapered portion is placed in said bearing.

6. A starter comprising:
a motor generating a rotational force;
a tube rotating in response to the rotational force transmitted from said motor and having a substantially cylindrical body;
an output shaft being coupled via a helical spline coupling at one axial end side with an inner cylindrical surface of said tube, and said output shaft protruding out of said tube at the other axial end side and being rotatably and slidably supported by a first bearing fixed to a housing;
a pinion gear integrally or separately disposed on an end portion of said output shaft protruding outward from said first bearing, for transmitting the rotational force transmitted from said tube via said output shaft to a ring gear of an engine; and
output shaft shifting means for shifting said output shaft toward said engine so that said pinion gear can mesh with said ring gear, wherein
an inner cylindrical surface of said substantially cylindrical tube is rotatably supported at one end side via a second bearing by a bearing portion provided on a rotary shaft of said motor;
an outer cylindrical surface of said substantially cylindrical tube is rotatably supported at the other end side via a third bearing by said housing or by a structural member supported by said housing; and
said output shaft shifting means includes an engaging member fixed to said output shaft protruding from said tube toward said ring gear and actuating means for giving a pushing force acting in the axial direction to said output shaft via said engaging member.

7. The starter in accordance with claim 6, wherein said second bearing is fixed to the inner cylindrical surface of said tube by press fitting.

8. The starter in accordance with claim 6, further comprising a clutch for allowing or prohibiting power transmission between said motor and said tube, wherein said clutch includes a clutch outer and a clutch inner rotatably coupled with each other, said clutch outer is directly or indirectly driven by said motor, said clutch inner receives the power of the motor transmitted from said clutch outer, and said clutch inner is formed as part of said tube.

9. The starter in accordance with claim 8, further comprising a planetary gear type speed-reduction unit having planetary gears causing an orbital motion for reducing the rotation of said motor,
wherein said clutch outer is provided with a carrier portion to which gear shafts are integrally or separately fixed for rotatably supporting said planetary gears, and
said carrier portion has a coupling hole rotatably coupling around said outer cylindrical surface of said tube at one end.

10. The starter in accordance with claim 8, wherein said clutch has an outer plate provided integrally with said clutch outer, said outer plate has a bore opened at a radial central region, a driven gear or a direct spline is formed on an inner side of said bore, and said driven gear or said direct spline meshes with a drive gear or a direct spline formed on said rotary shaft of said motor, so that said clutch outer is directly driven by said motor.

11. The starter in accordance with claim 6, wherein said actuating means includes an electromagnetic switch for generating an electromagnetic force, and a rotation restricting member driven by the electromagnetic force generated from said electromagnetic switch and engaging with said engaging member to restrict rotation of said output shaft before said output shaft starts rotating, and
said output shaft shifts toward the engine under a condition that rotation of said output shaft is restricted by said rotation restricting member, by using the rotational force of said motor and a function of said helical spline.

12. The starter in accordance with claim 6, wherein said actuating means includes an electromagnetic switch for generating an electromagnetic force, and a shift lever driven by said electromagnetic switch, and
said output shaft shifts toward the engine in response to a pushing force given via said shift lever to said engaging member in the axial direction.

13. A starter comprising:
a motor generating a rotational force;
a tube rotating in response to the rotational force transmitted from said motor and having a substantially cylindrical body;
an output shaft being coupled at one axial end side with an inner cylindrical surface of said tube via a helical spline coupling, and said output shaft protruding out of said tube at the other axial end side and being rotatably and slidably supported by a bearing fixed to a housing;
a pinion gear integrally or separately disposed on an end portion of said output shaft protruding outward from said bearing, for transmitting the rotational force transmitted from said tube via said output shaft to a ring gear of an engine; and
output shaft shifting means for shifting said output shaft toward said engine so that said pinion gear can mesh with said ring gear, wherein
said output shaft shifting means includes:
an engaging member fixed to said output shaft protruding from said tube toward said ring gear;
a rotation restricting member engageable with said engaging member before said output shaft starts rotating so as to restrict rotation of said output shaft; and
an electromagnetic switch for generating an electromagnetic force to drive said rotation restricting member, wherein
said output shaft shifts toward the engine under a condition that rotation of said output shaft is restricted by said rotation restricting member, by using the rotational force of said motor and a function of said helical spline.

14. The starter in accordance with claim 13, wherein said electromagnetic switch performs an open and close control of a contact means for selectively supplying electric power to said motor.

15. The starter in accordance with claim 13, wherein said engaging member fixed to said output shaft collides with an end surface of said tube during a shifting movement of said output shaft returning from the vicinity of said ring gear of said engine, so that said tube acts as a stopper for receiving a rearward shifting force of said output shaft and stopping said output shaft.

16. The starter in accordance with claim 13, further comprising a return spring generating an elastic force for pushing said output shaft back against a shifting movement of said output shaft toward said engine, wherein said return spring is disposed between an outer cylindrical surface of said output shaft being inserted into an inner space of said tube and an inner cylindrical surface of said tube,
said return spring has one end supported by a spring receiving portion provided on the outer cylindrical surface of said output shaft, and
said return spring has the other end supported by a spring receiving portion provided on the inner cylindrical surface of said tube.

17. The starter in accordance with claim 11, wherein said electromagnetic switch performs an open and close control of a contact means for selectively supplying electric power to said motor.

18. The starter in accordance with claim 12, wherein said electromagnetic switch performs an open and close control of a contact means for selectively supplying electric power to said motor.

19. The starter in accordance with claim 6, wherein said engaging member fixed to said output shaft collides with an end surface of said tube during a shifting movement of said output shaft returning from the vicinity of said ring gear of said engine, so that said tube acts as a stopper for receiving a rearward shifting force of said output shaft and stopping said output shaft.

20. The starter in accordance with claim 6, further comprising a return spring generating an elastic force for pushing said output shaft back against a shifting movement of said output shaft toward said engine, wherein
said return spring is disposed between an outer cylindrical surface of said output shaft being inserted into an inner space of said tube and an inner cylindrical surface of said tube,
said return spring has one end supported by a spring receiving portion provided on the outer cylindrical surface of said output shaft, and
said return spring has the other end supported by a spring receiving portion provided on the inner cylindrical surface of said tube.
